(19) United States
(12) Patent Application Publication
(10) Pub. No.: US 2007/0116445 A1
(43) Pub. Date: May 24, 2007

(54) Lens drive device and manufacturing method

(76) Inventors: Masahiro Kozakai, Nagano (JP); Hidekazu Yoneyama, Nagano (JP); Noboru Otsuki, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/581,784

(22) PCT Filed: Aug. 20, 2004
(86) PCT No.: PCT/JP04/11962

§ 371 Date: Jun. 5, 2006

(30) Foreign Application Priority Data
Dec. 5, 2003 (JP) 2003-407634

(51) Int. Cl. G03B 17/00

(52) U.S. Cl. 396/55

(57) ABSTRACT

A lens drive device is provide which includes a movable lens body having a lens, a drive element for moving the movable lens body in an optical axis direction of the lens, and a fixing body which movably supports the movable lens body in the optical axis direction. The movable lens body has a lens-barrel provided with a lens and a lens-barrel holder which movably supports the lens-barrel in the optical axis direction. The lens-barrel holder is provided with a first magnetic element as the drive element. The fixing body has a second magnetic element as the drive element and a regulating part which regulates a moving range in the optical axis direction of the lens-barrel holder. The movable lens body is moved by a magnetic attractive force or a magnetic repulsive force between the first magnetic element and the second magnetic element.

### CROSS-REFERENCE TO RELATED APPLICATIONS

This application claims priority of International Application No. PCT/JP2004/011962, filed Aug. 20, 2004, and Japanese Application No. 2003-407634, filed Dec. 5, 2003, the complete disclosures of which are hereby incorporated by reference.

### FIELD OF THE INVENTION

The present invention relates to a lens drive device which is used in a relatively small camera such as a camera for a portable telephone with a camera or the like and a manufacturing method for the lens drive device.

### BACKGROUND OF THE INVENTION

In a portable telephone on which a camera is mounted, the portable telephone is often used such that the portable telephone is held by one hand to photograph user's own face or other object at a close position. Therefore, a photographing lens system used in this type of camera is frequently provided with a close-up photographing function. In the case of the photographing lens system provided with a close-up photographing function, the lens position at the time of performing normal photographing is different from the lens position at the time of performing close-up photographing, i.e., macro-photographing. In other words, the lens position at the time of close-up photographing is located at a position slightly nearer by a certain distance to an object to be photographed from a lens position at the time of normal photographing.

Therefore, in this type of the photographing lens system, a magnetic-drive mechanism for moving the lens between the normal photographing position and the macro photographing position is provided and the magnetic-drive mechanism is driven by the changeover of a switch to move the lens between the two photographing positions described above.

Conventionally, the focus of a photographing lens system is secured by merely improving the precision of components or, when the focus is to be adjusted, the adjustment is performed so as to set to focus on an imaging element by moving a lens-barrel to a lens position for the normal photographing, a lens position for the macro-photographing or both of the lens positions. Further, since the imaging element is often mounted by a user, focus is confirmed by using a CCD camera or the like before the imaging element is mounted.

However, a small camera, particularly the camera portion of a portable telephone is provided with an extremely small diameter of about 10 mm and its focal length is extremely short. Therefore, even when the precision of the components is secured, mounting errors are likely to occur to cause to have a problem of out of focus. Further, when focus adjustment is performed by moving the lens-barrel provided with a magnetic drive means in an optical axis direction, the positional relationship between the drive means provided in the lens-barrel and a drive means provided in a fixing body side is varied and thus thrust balance is varied. As a result, there is a problem that, when the lens-barrel is moved between the normal photographing position and the macro-photographing position, the operation of the lens-barrel becomes unstable and, depending on its stopped position, in the worst case, the lens-barrel is unable to be driven again. This operating malfunction is avoidable by increasing a thrust force of the drive means but the drive means is caused to be larger and thus it is not avoidable that the size of the lens drive device is increased. In addition, even when focus adjustment has been performed by using a CCD camera with a high degree of precision before an imaging element is mounted, since the imaging element is mounted after the focus adjustment, the focus of the lens with respect to the imaging element is shifted by the dimensional error of the imaging element or the mounting error of the imaging element, and thus a lens drive device with a stable quality cannot be obtained.

In view of the problems described above, it is an object of the present invention to provide a lens drive device with a stable quality which is capable of performing focus adjustment of a lens with respect to an imaging element while the positional relationship of a drive means is maintained.

### SUMMARY OF THE INVENTION

In order to solve the problems described above, the present invention is characterized in that, in a lens drive device including a movable lens body provided with a lens, a drive means for moving the movable lens body in an optical axis direction of the lens, and a fixing body which movably supports the movable lens body in the optical axis direction, the movable lens body is comprised of a lens-barrel provided with a lens and a lens-barrel holder which movably supports the lens-barrel in the optical axis direction, the lens-barrel holder comprises a first magnetic means as the drive means, the fixing body comprises a second magnetic means as the drive means and a regulating part which regulates a moving range in the optical axis direction of the lens-barrel holder, and the movable lens body is moved by a magnetic attractive force or a magnetic repulsive force between the first magnetic means and the second magnetic means.

In the present invention, it is preferable that the lens-barrel holder is formed in a cylindrical shape and a female screw part is formed on its inner periphery, and a male screw part is formed on the outer periphery of the lens-barrel and the male screw part is threadedly engaged with the female screw part, and the lens-barrel is moved in the optical axis direction by relatively turning the lens-barrel holder with respect to the lens-barrel. According to the structure described above, the lens-barrel can be supported on the lens-barrel holder by the threaded engagement of screws. Therefore, adjustment work for focusing can be easily and surely performed and furthermore, after the adjustment, fixing work of the lens-barrel to the lens-barrel holder can be also easily and surely performed.

In order to manufacture a lens drive device in accordance with the present invention, it is preferable that the fixing body is structured as a case body inside of which the movable lens body is accommodated, the case body is structured to be capable of being divided into at least two portions such that respective portions are formed as half case bodies, the lens-barrel holder is abutted with an abutting part as the regulating part which is provided in one of the half case bodies, the one of the half case bodies and the other half case body are relatively moved in the optical axis direction such that a spacer is interposed between an abutting part as the regulating part provided in the other half case body and the lens-barrel holder, after that, the one of the half case bodies and the other half case body are fixed each other, and after that, the spacer is pulled out. According to the structure as described above, the stroke length of the lens-barrel holder corresponding to the thickness of the spacer can be formed. In other words, the stroke length of the lens-barrel holder with the regulating part of the fixing body can be easily and surely formed.

In order to manufacture a lens drive device in accordance with the present invention, it is preferable that the fixing body is structured as a case body inside of which the movable lens body is accommodated, the case body is structured to be capable of being divided into at least two portions such that respective portions are formed as half case bodies, abutting parts as the regulating parts which interpose the lens-barrel holder are provided on one of the half case bodies and the other half case body respectively, a gap space between the abutting parts is adjusted and the one of the half case bodies and the other half case body are fixed to each other, after that, an imaging element where an image transmitted through the lens is image-formed is fixed to the half case body, after that, the lens-barrel and the lens-barrel holder are relatively moved in the optical axis direction to adjust the focus of the lens to the imaging element. According to the structure as described above, even when the dimensional accuracy of the imaging element is not satisfactory or even when the focus of the lens to the imaging element shifts due to the mounting error of the imaging element or the like, since focus adjustment between the lens and the imaging element can be performed after the imaging element are mounted, a lens drive device with stable quality can be provided.

According to the present invention, since the movable lens body is structured of two components, i.e., the lens-barrel and the lens-barrel holder, focus adjustment can be performed by moving the lens-barrel in the optical axis direction with respect to the lens-barrel holder. Therefore, the position of the regulating part which regulates the moving range in the optical axis direction of the lens-barrel holder can be maintained, and the positional relationship between the first magnetic means provided in the lens-barrel holder as the drive means and the second magnetic means provided in the fixing body can be maintained. A method may be conceivable in which the position of the regulating part is varied to perform the focus adjustment. However, when the position of the regulating part is varied, the positional relationship of the drive means varies in accordance with the variation of the position of the regulating part. Therefore, designing in consideration of thrust force balance is required such that the variation of the positional relationship of the drive means can be permitted, and thus the size of the device is increased. According to the present invention, since the positional relationship between the first magnetic means and the second magnetic means is maintained, even when focus adjustment is performed, the thrust force balance between the first magnetic means and the second magnetic means does not vary. Therefore, designing in consideration of the unvaried thrust force balance, in other words, designing based on the minimum thrust force balance can be performed and the size of the lens drive device can be reduced. Further, interference due to focus adjustment between the first magnetic means and the second magnetic means can be avoided.

A lens drive device in accordance with an embodiment of the present invention will be described below with reference to the accompanying drawings. A manufacturing method for the lens drive device and a portable device with a camera will be described at the same time. Respective embodiments are structured suitable to be mounted as a camera portion of a portable device such as a portable telephone but may be mounted on other portable devices such as a PDA (Personal Digital Assistance).

### BRIEF DESCRIPTION OF THE DRAWINGS

FIG. 1 is a sectional view showing a lens drive device in accordance with the present invention;

FIG. 2 is an exploded perspective view showing the lens drive device shown in FIG. 1;

FIG. 3 is an exploded cross-sectional view showing the lens drive device shown in FIG. 1;

FIG. 4 is a sectional view showing an essential portion of the lens drive device shown in FIG. 1;

FIG. 5 is a sectional view of a second divided case body portion which shows a state where a spacer is set in the lens drive device shown in FIG. 1;

FIG. 6 is a plan view showing a spacer which is used when the lens drive device in FIG. 1 is manufactured; and

FIG. 7 is a plan view showing a magnet which is used in the lens drive device in FIG. 1.

### DETAILED DESCRIPTION OF THE DRAWINGS

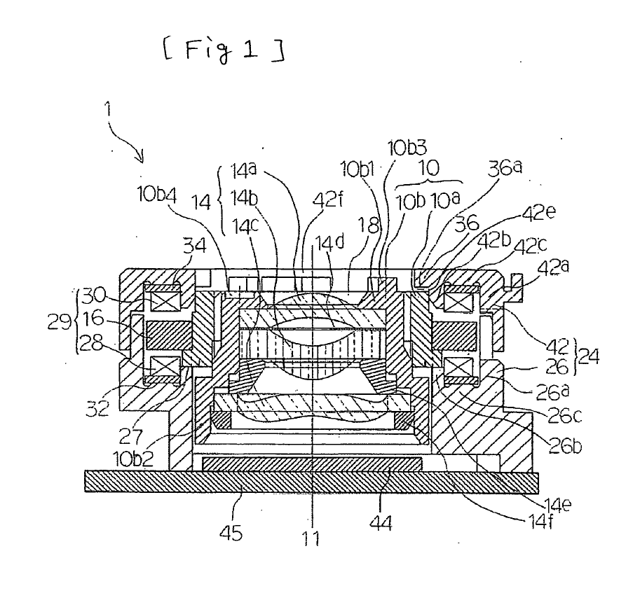

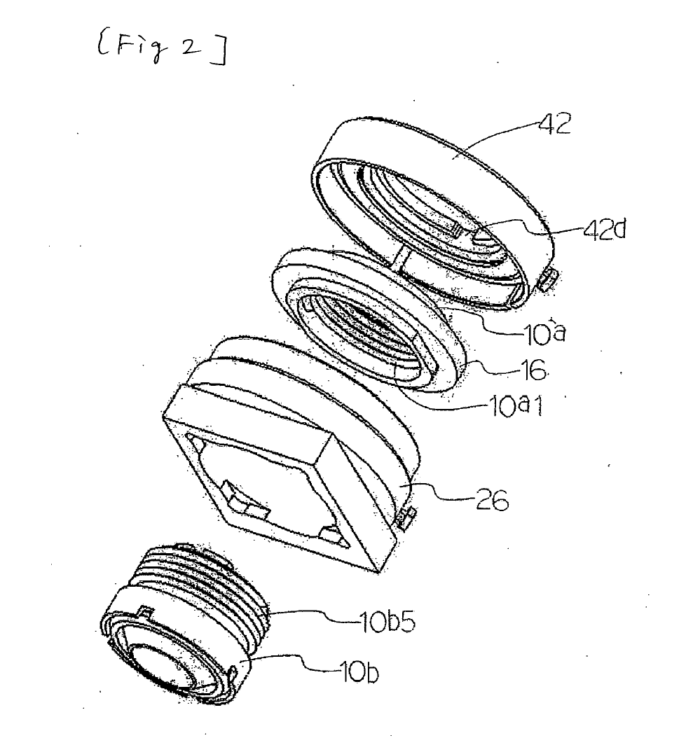

FIG. 1 is a sectional view showing a lens drive device in accordance with the present invention. FIG. 2 is an exploded perspective view showing the lens drive device shown in FIG. 1.

As shown in FIG. 1 or FIG. 2, the lens drive device 1 mainly includes a movable lens body 10 which holds a lens 14 of a camera for photographing, a magnetic drive means 29 for linearly moving the movable lens body 10 along the direction of an optical axis 11 of the lens 14, a case body 24 which is a fixing body for accommodating the movable lens body 10 and the magnetic drive means 29, an imaging element 44 where an image passing through the lens 14 is formed, and a circuit board 45 on which the imaging element 44 is fixed. In this embodiment, the imaging element 44 is comprised of a CMOS (Complementary Metal Oxide Semiconductor).

The movable lens body 10 includes a lens-barrel 10b provided with a lens 14 in the inside of a pipe body and a lens-barrel holder 10a which supports the lens-barrel 10b movably in the direction of the optical axis 11. The lens-barrel 10b is provided at one end with a bottomed part 10b1 having a circular incident window 18 for taking a reflected light from an object to be photographed to the lens 14 at a center portion. The bottomed part 10b1 is disposed on the upper side in FIG. 1. An engaging protrusion part 10b3 and an engaging groove 10b4, which are formed for turning the lens-barrel 10b by using a specified jig, are formed on the upper face in the drawing of the bottomed part 10b1 in the direction of the optical axis 11 in a protruded or recessed manner. Further, the upper part in FIG. 1 of the lens-barrel 10b is formed in a small diameter portion and the lower part is formed in a large diameter portion whose diameter is larger than the small diameter portion. A male screw part 10b5 is formed on the outer wall of the small diameter portion (see FIG. 2). The lens 14 is disposed in the order of an object side lens 14a, an intermediate lens 14b and a camera body side lens 14c from the bottomed part 10b1 side of the lens-barrel 10b. A position fixing member 14f is fixed to the entrance 10b2 of the lens-barrel 10b so as to hold three pieces of lens 14. The clearance between the object side lens 14a and the intermediate lens 14b are held to be in a constant state by a spacer 14d, which serves as a diaphragm, and the clearance between the intermediate lens 14b and the camera body side lens 14c is held to be in a constant state by a spacer 14e.

The lens-barrel holder 10a is formed in a cylindrical shape. The outer periphery of the upper portion in FIG. 1 is formed in a small diameter portion and the outer periphery of the lower portion is formed in a large diameter portion whose diameter is larger than that of the small diameter portion and a stepped portion is formed at the boundary of the small diameter portion and the large diameter portion. A female screw part 10a1 is formed on the inner wall of the lens-barrel holder 10a (see FIG. 2). The female screw part 10a1 is threadedly engaged with the male screw part 10b5. In other words, the lens-barrel 10b is rotatably engaged in and with the lens-barrel holder 10a and, by rotating the lens-barrel 10b, the lens-barrel 10b can be moved to the lens-barrel holder 10a in the direction of the optical axis 11. The lens-barrel holder 10a is formed with a rotation preventing part not shown in the drawing which is protruded from its upper face. The rotation preventing part is engaged with a rotation preventing groove 42d which is formed on a second divided case body 42. Therefore, turning of the lens-barrel holder 10a together with the lens-barrel 10b is prevented when the lens-barrel 10b is turned, and thus the lens-barrel 10b can be efficiently moved.

A drive magnet 16, which is a first magnetic means and is formed in a ring shape, is fitted on the small diameter portion of the lens-barrel holder 10a. The drive magnet 16 is integrally fixed to the lens-barrel holder 10a in the state that the drive magnet 16 is abutted with the stepped portion. The drive magnet 16 is, as shown in FIG. 7, magnetized into a single pole such that the portion surrounding a center hole is magnetized in an N-pole and the entire outer peripheral portion is magnetized in an S-pole respectively. Alternatively, the magnetized relationship of NS may be reversed.

The case body 24 is structured of the first divided case body 26 and a second divided case body 42. In this embodiment, as shown in FIG. 1, the first divided case body 26 is disposed on the lower side and the second divided case body 42 is disposed on the upper side. The first divided case body 26 and the second divided case body 42 are integrated with each other by means of that cylindrical protruded portions, which are protruded in the direction of the optical axis 11 from respective outer tubular parts 26a, 42a, are engaged with each other radially. A pair of drive coils 28, 30, which are a second magnetic means and formed in a ring shape, are respectively fixed to the first and the second divided case bodies 26, 42. Further, a circuit board 45 is fixed on the under face of the first divided case body 26.

The first divided case body 26 is formed in a tubular shape and an inner tubular part 26b is formed on the inner side in the radial direction of the outer tubular part 26a along a circumferential direction of the outer tubular part 26a. The outer tubular part 26a and the inner tubular part 26b are connected through a connecting part 26c and a U-shaped groove whose cross section is formed in a “U” shape is formed by the outer tubular part 26a, the inner tubular part 26b and the connecting part 26c. The upper end face of the inner tubular part 26b is an end face 27 as one of regulating parts (abutting part) with which the lower end face of the lens-barrel holder 10a abuts at a normal photographing position shown in FIG. 1.

The second divided case body 42 is formed in a tubular shape that is provided with an aperture 42f at its upper part in FIG. 1. Further, the second divided case body 42 is provided with an inner tubular part 42b that is extended along a circumferential direction of the outer tubular part 42a on the inner side in the radial direction of the outer tubular part 42a. The outer tubular part 42a and the inner tubular part 42b are connected through a connecting part 42c and a U-shaped groove is formed by the outer tubular part 42a, the inner tubular part 42b and the connecting part 42c. A protruding edge 36, which is the other of the regulating parts (abutting part) with which the upper end face of the lens-barrel holder 10a abuts at a macro-photographing position where the lens-barrel holder 10a moves upward from the normal photographing position shown in FIG. 1, is formed on the inner tubular part 42b. The protruding edge 36 is formed with a turning prevention groove 42d (see FIG. 2) which is to be engaged with the rotation preventing part that is protruded from the upper face of the lens-barrel holder 10a. Further, the protruding edge 36 is provided with a protruded part 36a which protrudes downward in the direction of the optical axis 11. The inner wall side of the inner tubular part 42b is formed to be a sliding part 42e which abuts with the outer wall on the upper end side of the lens-barrel holder 10a as a guide portion when the lens-barrel holder 10a moves in the direction of the optical axis 11.

A first magnetic piece 32 and a second magnetic piece 34 formed in a ring shape are fixed on the respective bottoms of the U-shaped grooves which are formed in the first divided case body 26 and the second divided case body 42. The first drive coil 28 and the second drive coil 30 are fixed on the first magnetic piece 32 and the second magnetic piece 34 such that their inner walls are abutted with the inner tubular parts 26b, 42b and the first drive coil 28 and the second drive coil 30 are accommodated within the U-shaped grooves. Further, the first drive coil 28 and the second drive coil 30 face each other in the direction of the optical axis 11 and the first magnetic body 32 and the second magnetic body 34 are respectively disposed on the outer side in the direction of the optical axis 11 of the first and the second drive coils 28, 30.

The movable lens body 10 is housed in the case body 24 such that the upper and the under faces in the drawing of the drive magnet 16 which is provided on the lens-barrel holder 10a is located between the first drive coil 28 and the second drive coil 30. In other words, the drive magnet 16 is interposed in the direction of the optical axis 11 between the first and the second drive coils 28, 30. Therefore, the lens-barrel holder 10a slides on the sliding part 42e and moves in the direction of the optical axis 11 while the drive magnet 16 moves in the direction of the optical axis 11 by one or both of the first drive coil 28 and the second drive coil 30 that are energized. In this case, the lower end side of the lens-barrel holder 10a is not abutted with any portion so as to be allowed in a free condition.

The distance between the opposite faces of the first and the second drive coils 28, 30 is formed larger than the thickness of the drive magnet 16 in the direction of the optical axis 11 and thus a space in the direction of the optical axis 11 is formed between the drive magnet 16 and the first drive coil 28 or the second drive coil 30. Therefore, the drive magnet 16 is capable of moving in the range of the space and thus the lens-barrel holder 10a integrally formed with the drive magnet 16 is also capable of moving in the direction of the optical axis 11 in the range of the space.

On the other hand, at the normal photographing position shown in FIG. 1, the bottom end face of the lens-barrel holder 10a abuts with the end face 27 of the inner tubular part 26b. Therefore, it is structured such that a little clearance is formed between the first drive coil 28 and drive magnet 16, and thus a collision between the first drive coil 28 and the drive magnet 16 is prevented. Therefore, the damage of the first drive coil 28 or the drive magnet 16 can be prevented.

Similarly as described above, also at the macro-photographing position where the lens-barrel holder 10a has been moved upward from the normal photographing position shown in FIG. 1, it is structured such that the upper end face of the lens-barrel holder 10a abuts with the protruding edge 36 and thus a little clearance is formed between the second drive coil 30 and the drive magnet 16 and a collision between the second drive coil 30 and the drive magnet 16 is prevented. Therefore, the damage of the second drive coil 30 or the drive magnet 16 can be prevented. The turning prevention groove 42d always engages with the turning preventing part which is protruded from the upper face of the lens-barrel holder 10a even when the lens-barrel holder 10a moves between the normal photographing position and the macro-photographing position.

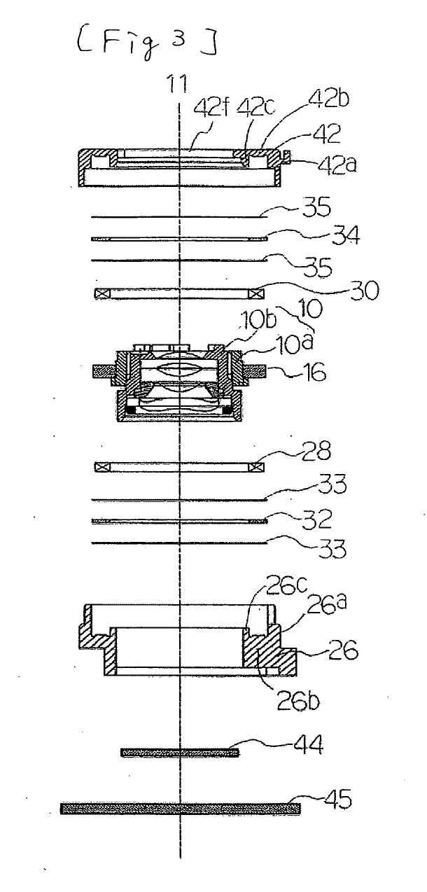

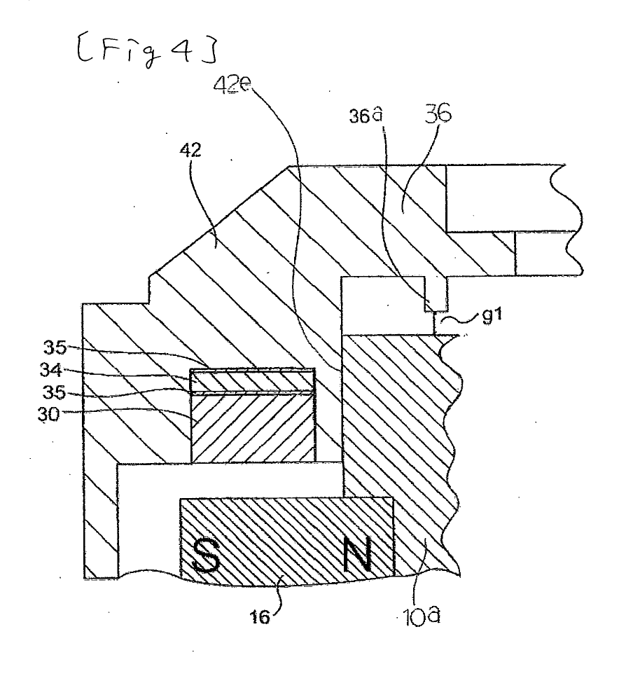

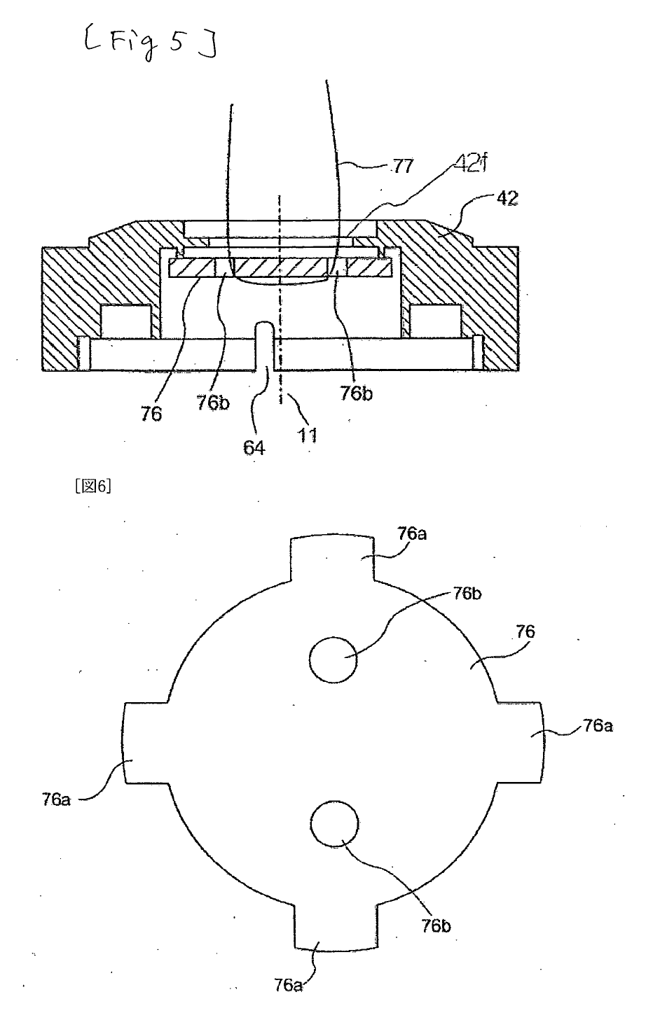

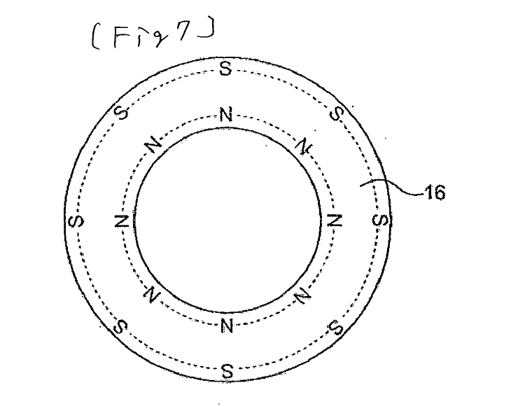

Next, a manufacturing method for the lens drive device 1 will be described with reference to FIGS. 3 through 6. FIG. 3 is an exploded sectional view showing the lens drive device shown in FIG. 1. FIG. 4 is a sectional view showing an essential portion of the lens drive device shown in FIG. 1. FIG. 5 is a sectional view showing a second divided case body to which a spacer is fitted in the lens drive device shown in FIG. 1. FIG. 6 is a plan view showing a spacer that is used when the lens drive device in FIG. 1 is manufactured.

First, the first magnetic body 32 and the first drive coil 28 are successively disposed on the first divided case body 26. Pressure sensitive adhesive sheets 33 that serve as an adhesive are, as shown in FIG. 3, stuck on the both sides of the first magnetic body 32.

Similarly, the second magnetic body 34 and the second drive coil 30 are successively disposed to the second divided case body 42. Pressure sensitive adhesive sheets 35 are also stuck on the both sides of the second magnetic body 34. After that, the movable lens body 10, which is structured by the lens-barrel 10b threadedly engaged with the lens-barrel holder 10a in advance, is housed in the case body 24 such that the movable lens body 10 is interposed between the first and the second divided case bodies 26, 42.

Next, the moving range of the lens-barrel holder 10a housed in the case body 24 between the macro-photographing position and the normal photographing position, in other words, the stroke length of the lens-barrel holder 10a is adjusted. FIG. 4 is a cross sectional view showing an essential portion in the state that the lens-barrel holder 10a is abutted with the end face 27 of the first divided case body 26 as the lower moving limit. The gap “g1” which is the largest gap length between the protruded part 36a provided on the protruding edge 36 that is the upper abutting part and the lens-barrel holder 10a corresponds to the stroke length of the lens-barrel holder 10a.

A spacer 76 is used to adjust the gap “g1”. The spacer 76 is, as shown in FIGS. 5 and 6, formed in a flat plate shape and provided with a plurality of protruded parts 76a on its outer periphery and two through-holes 76b at its center portion. When the gap “g1” is adjusted, a thread 77 is passed through the two through-holes 76b of the spacer 76.

Before the first and the second divided case bodies 26, 42 are fitted to each other, the spacer 76 under the state that one piece of thread 77 is passed through the two through-holes 76b is disposed between the second divided case body 42 and the lens-barrel holder 10a as shown in FIG. 5. Both ends of one piece of the thread 77 are drawn out outside from the aperture 42f of the second divided case body 42. In this state, the first and the second divided case bodies 26, 42 are temporarily fixed. Then, the first divided case body 26 and the second divided case body 42 are moved close to each other in the direction of the optical axis 11 such that the spacer 76 is firmly sandwiched by the protruded part 36a and the lens-barrel holder 10a. When the spacer 76 is firmly sandwiched by the first and the second divided case bodies 26, 42, they are completely integrated with each other with an adhesive or welding. After that, the spacer 76 is pulled out through the aperture 42f by holding and pulling both the ends of the thread 77. As a result, the gap “g1” that is the largest gap length becomes to be the same as the thickness of the spacer 76.

The case body portion in which the stroke length of the lens-barrel holder 10a is determined as described above is delivered to a camera maker or a portable device maker. An imaging element 44 and a circuit board 45 are fixed on the maker side to the case body portion which has been delivered. After that, the lens-barrel 10b and the lens-barrel holder 10a are relatively moved to adjust the focus of the lens to the imaging element 44. This adjustment is performed such that a jig is engaged with the engaging protrusion part 10b3 or the engaging groove 10b4 provided in the lens-barrel 10b to turn and move the lens-barrel 10b in the direction of the optical axis 11, and such that an image at the normal photographing position or the macro-photographing position is obtained, and such that the lens-barrel and the lens-barrel holder are fixed at a position where the image balance is satisfactory.

As described above, in the lens drive device 1 in accordance with this embodiment, the movable lens body 10 comprises the lens-barrel 10b provided with the lens 14 and a lens-barrel holder 10a which movably supports the lens-barrel 10b in the direction of the optical axis 11. Therefore, focus adjustment can be performed by moving the lens-barrel 10b in the optical axis direction. In other words, the positions of the end face 27 and the protruding edge 36 as the regulating parts for regulating the moving range in the direction of the optical axis 11 of the lens-barrel holder 10a can be maintained and the positional relationship between the drive magnet 16 and the first drive coil 28, the second drive coil 30 which are a drive means can be maintained in a constant state at the normal photographing position or the macro-photographing position. Therefore, even when focus adjustment is performed, the thrust force balance between the drive magnet 16 and the first drive coil 28 and the second drive coil 30 does not vary. As a result, designing in consideration of the unvaried thrust force balance, in other words, designing based on the minimum thrust force balance can be performed and the size of the lens drive device 1 can be reduced. Further, interference due to focus adjustment between the drive magnet 16 and the first drive coil 28 or the second drive coil 30 can be avoided.

Further, the female screw part 10a1 formed on the inner periphery of the lens-barrel holder 10a is threadedly engaged with the male screw part 10b1 formed on the outer periphery of the lens-barrel 10b, and the lens-barrel 10b can be moved in the direction of the optical axis 11 by relatively turning the lens-barrel holder 10a with respect to the lens-barrel 10b. Further, since the lens-barrel 10b can be supported by the lens-barrel holder 10a with threaded engagement of screws, adjustment work for focusing can be easily and surely performed and furthermore, after the adjustment, fixing work of the lens-barrel 10b to the lens-barrel holder 10a can be also easily and surely performed.

In addition, in the assembling of the lens drive device 1, the case body 24 for accommodating the movable lens body 10 is comprised of the first divided case body 26 and the second divided case body 42 each of which is a half case body. Further, the lens-barrel holder 10a is abutted with the end face 27 formed in the first divided case body 26 and, after the first divided case body 26 and the second divided case body 42 are relatively moved in the direction of the optical axis 11 such that the spacer 76 is sandwiched between the protruded part 36a of the protruding edge 36 formed in the second divided case body 42 and the lens-barrel holder 10a, the first divided case body 26 and the second divided case body 42 are fixed to each other and then the spacer 76 is pulled out. Therefore, the stroke length of the lens-barrel holder 9a corresponding to the thickness of the spacer 76 can be formed. Accordingly, the stroke length of the lens-barrel holder 10a with respect to the end face 27 of the first divided case body 26 and the protruding edge 36 of the second divided case body 42 can be easily and surely formed.

In addition, in the assembling of the lens drive device 1, the case body 24 accommodating the movable lens body 10 is comprised of the first divided case body 26 and the second divided case body 42 each of which is a half case body, and the first divided case body 26 and the second divided case body 42 are provided with the end face 27 and the protruding edge 36 that are the abutting parts respectively as the regulating part for interposing the lens-barrel holder 10a. Further, after the gap space between the abutting parts is adjusted and then the first divided case body 26 and the second divided case body 42 are fixed to each other, and the imaging element 44 to which an image transmitted through the lens 14 is formed is fixed to the first divided case body 26 via the circuit board 45 and, after that, the lens-barrel 10b and the lens-barrel holder 10a are relatively moved to adjust the focus of the lens 14 to the imaging element 44. Therefore, after the imaging element 44 has been mounted, focus adjustment between the lens 14 and the imaging element 44 can be performed. Accordingly, even when the dimensional accuracy of the imaging element 44 is not satisfactory or even when the focus of the lens 14 to the imaging element 44 shifts due to the mounting error of the imaging element 44, a lens drive device with stable quality can be provided without a problem.

In this embodiment, the outer wall on the upper end side of the lens-barrel holder 10a is abutted with the sliding part 42e as a guide portion which is formed on the second divided case body 42 and its lower end side is not abutted anywhere and is always allowed to be in a free condition. If a guide portion which guides the lower end side of the lens-barrel holder 10a is provided on the first divided case body 26, respective guide portions on the upper end side and the lower end side of the lens-barrel holder 10a are separately formed on different members. In this case, if the positional accuracy between the two guide portions is not secured, the operational malfunction of the lens-barrel holder 10a may occur. However, in this embodiment, since the lower end side of the lens-barrel holder 10a is allowed in a free state, the problem described above is prevented. Moreover, frictional resistance due to sliding does not occur on the lower end side and thus a load can be reduced and the size of the magnetic drive means 29 can be reduced. In addition, when the lens-barrel holder 10a moves to the normal photographing position (lower side) from the macro-photographing position (upper side), the tip end (lower end) in the moving direction of the lens-barrel holder 10a does not interfere with the inner wall of the inner tubular part 26b of the first divided case body 26 and thus operational malfunction does not occur.

Since only the upper end side of the lens-barrel holder 10a is guided, the lens-barrel holder 10a may have a possibility of inclination with respect to the direction of the optical axis 11 at an intermediate position between the normal photographing position and the macro-photographing position. However, in this embodiment, since photographing is not performed at the intermediate position, the inclination of the lens-barrel holder 10a does not cause a problem. Even when the lens-barrel holder 10a inclines at an intermediate position, when the lens-barrel holder 10a has moved to the normal photographing position, the bottom end face of the lens-barrel holder 10a abuts with the opposite end face 27 of the inner tubular part 26b and thus the inclination of the lens-barrel holder 10a can be corrected. Similarly, when the lens-barrel holder 10a has moved to the macro-photographing position, the upper end face of the lens-barrel holder 10a abuts with the opposite protruding edge 36 of the inner tubular part 42b and thus the inclination of the lens-barrel holder 10a can be corrected.

In this embodiment, the first and the second magnetic bodies 32, 34 are respectively disposed on the outer side in the direction of the optical axis 11 of the first drive coil 28 and the second drive coil 30 so as to have a function as a back yoke and, in addition, have a function to hold the position of the lens-barrel holder 10a together with the drive magnet 16. In other words, at the normal photographing position shown in FIG. 1, even when an electric current is not applied to the drive coils 28 and 30, the position of the lens-barrel holder 10a can be held by a magnetic attractive force generated between the drive magnet 16 and the first magnetic body 32. Similarly, at the macro-photographing position where the lens-barrel holder 10a has moved upwards from the normal photographing position, even when an electric current is not applied to the drive coils 28 and 30, the position of the lens-barrel holder 10a can be held by a magnetic attractive force generated between the drive magnet 16 and the first magnetic body 32.

The embodiment described above is a preferred example of the present invention but many modifications can be made without departing from the present invention. For example, in the embodiment shown in FIG. 2, the female screw part 10a1 is formed on the inner wall of the lens-barrel holder 10a and the male screw part 10b1 is formed on the outer wall of the lens-barrel 10b, and the female screw part 10a1 and the male screw part 10b1 are threadedly engaged with each other. However, threaded engagement is not always required and engagement with a cam may be used when the lens-barrel holder 10a is capable of movably supporting the lens-barrel 10b in the direction of the optical axis 11. Alternatively, simple light press-fitting may be utilized. In the case of the light press-fitting, a serration mechanism may be used to prevent turning around the optical axis 11 of the lens 14.

Further, in order to lightly press-fit the inner wall of the lens-barrel holder 10a with the outer wall of the lens-barrel 10b, their dimensional accuracies are required to be managed considerably strictly. Therefore, the inner wall of the lens-barrel holder 10a and the outer wall of the lens-barrel 10b may be structured in a loosely engaged state and an urging member having a spring property is protruded from one of them so as to abut with the other and thus the inner wall of the lens-barrel holder 10a and the outer wall of the lens-barrel 10b are abutted with each other in an urging state.

As a focus adjustment method in the case that the inner wall of the lens-barrel holder 10a and the outer wall of the lens-barrel 10b are lightly press-fitted to each other, for example, a following method may be utilized. In other words, through holes are respectively formed in the walls where the lens-barrel holder 10a and the lens-barrel 10b are radially overlapped with each other. An adjusting rod is inserted into both the through holes from the outside so as to engage with them simultaneously and focus adjustment can be performed by moving the adjusting rod in an upper and a lower directions.

Further, another adjustment method may be used. In other words, a circular hole is formed in the wall of the lens-barrel holder 10a which is radially overlapped with the lens-barrel 10b, and an elongated hole which is extended in a direction perpendicular to the optical axis 11 (circumferential direction of the outer peripheral face) is formed in the wall of the lens-barrel 10b which is radially overlapped with the lens-barrel holder 10a. The tip end of an eccentric pin is inserted through the circular hole from the outside and is engaged with the elongated hole and the eccentric pin is turned. In this manner, the lens-barrel 10b is moved in the direction of the optical axis 11 to adjust the focus.

In addition, as shown in FIG. 1, in this embodiment, the rotation preventing part for preventing co-rotation of the lens-barrel holder 10a with the lens-barrel 10b is formed on the lens-barrel holder 10a side. However, the rotation preventing part may be formed on the lens-barrel 10b side. In other words, any structure which can prevent the co-rotation of the lens-barrel holder 10a with the lens-barrel 10b may be utilized. Therefore, the turning prevention groove 42d formed on the protruding edge 36 which engages with the rotation preventing part not shown in the drawing is not always required to be formed on the protruding edge 36 and may be formed on the first divided case body 26 side.

In addition, as shown in FIG. 1, while the upper end side of the lens-barrel holder 10a is guided by the sliding part 42e which is formed on the inner wall side of the inner tubular part 42b, its lower end side moves in the direction of the optical axis 11 in a free state without being guided. However, a sliding part may be formed on the inner wall side of the inner tubular part 26b of the first divided case body 26 such that the lens-barrel holder 10a moves in the direction of the optical axis 11 while the upper and lower ends of the lens-barrel holder 10a are simultaneously guided.

In addition, in this embodiment, after the lens-barrel 10b is threadedly engaged with the lens-barrel holder 10a in advance, they are accommodated within the case body 24. However, at first, only the lens-barrel holder 10a may be accommodated in the case body 24 and, after that, the lens-barrel 10b is threadedly engaged with the lens-barrel holder 10a. In this case, it is preferable that a plurality of grooves is formed in the circumferential direction on the tip end of the entrance 10b2 of the lens-barrel 10b and the lens-barrel 10b is turned by a turning jig which is engaged with these grooves.

In addition, the imaging element 44 in this embodiment is comprised of a CMOS (Complementary Metal Oxide Semiconductor) but a CCD, a VMIS or the like may be utilized other than a CMOS. Further, the lens drive device 1 is incorporated as a mechanism for a camera portion in a cellular telephone with a camera. However, the lens drive device 1 may be used in other portable devices such as a mobile computer and a PDA or other camera devices such as a monitor camera and a camera for medical application, or may be incorporated into an electronic device for a car, a television or the like.

The present invention may be applied to a camera device. Further, the present invention may be applied to a portable device such as a cellular telephone provided with a camera function. In addition, the present invention can be incorporated into all electronic equipments when the electronic equipment is provided with a position changing mechanism for a lens.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

1. A lens drive device comprising a movable lens body provided with a lens, a drive means for moving the movable lens body in an optical axis direction of the lens, and a fixing body which movably supports the movable lens body in the optical axis direction,
wherein the movable lens body is comprised of a lens-barrel provided with a lens and a lens-barrel holder which movably supports the lens-barrel in the optical axis direction, the lens-barrel holder comprises a first magnetic means as the drive means, the fixing body comprises a second magnetic means as the drive means and a regulating part which regulates a moving range in the optical axis direction of the lens-barrel holder, and the movable lens body is moved by a magnetic attractive force or a magnetic repulsive force between the first magnetic means and the second magnetic means.

2. The lens drive device according to claim 1, wherein the lens-barrel holder is formed in a cylindrical shape and a female screw part is formed on its inner periphery, and a male screw part is formed on an outer periphery of the lens-barrel and the male screw part is threadedly engaged with the female screw part, and the lens-barrel is moved in the optical axis direction by relatively turning the lens-barrel holder with respect to the lens-barrel.

3. A manufacturing method for manufacturing the lens drive device comprising:
preparing a case body as the fixing body in which the movable lens body is accommodated inside of the case body, the case body being structured to be capable of being divided into at least two portions such that respective portions are formed as half case bodies,
abutting the lens-barrel holder with an abutting part as the regulating part which is provided in one of the half case bodies;
relatively moving the one of the half case bodies and the other half case body in the optical axis direction such that a spacer is sandwiched between an abutting part as the regulating part provided in the other half case body and the lens-barrel holder;
fixing the one of the half case bodies and the other half case body each other; and
pulling out the spacer.

4. A manufacturing method for manufacturing the lens drive device comprising:
preparing a case body as the fixing body in which the movable lens body is accommodated inside of the case body, the case body being structured to be capable of being divided into at least two portions such that respective portions are formed as half case bodies;
providing abutting parts as the regulating parts for interposing the lens-barrel holder on one of the half case bodies and the other half case body respectively;
adjusting a gap space between the abutting parts;
fixing the one of the half case bodies and the other half case body each other;
fixing an imaging element where an image transmitted through the lens is image-formed to the half case body; and
relatively moving the lens-barrel and the lens-barrel holder in the optical axis direction to adjust a focus of the lens to the imaging element.
